(19) United States
(12) Patent Application Publication
(10) Pub. No.: US 2006/0082537 A1
(43) Pub. Date: Apr. 20, 2006

(54) Liquid crystal display device and method of driving the same

(76) Inventor: Osamu Tabata, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/244,290

(22) Filed: Oct. 6, 2005

(30) Foreign Application Priority Data
Oct. 14, 2004 (JP) 2004-300119

(51) Int. Cl. G09G 3/36

(52) U.S. Cl. 345/100

(57) ABSTRACT

A liquid crystal display device include pixels arranged in a matrix on a substrate, columns of signal lines for supplying image signals to respective columns of pixels, rows of scanning lines for use in selecting respective rows of pixels, a signal line driving circuit including selecting circuits for supplying associated image signals in each of horizontal periods in such a manner as to supply image signals supplied through the signal lines and associate with a ½ horizontal line, and then other image signals supplied through the signal lines and associated with the other ½ horizontal line, a scanning line driving circuit connected to the plurality of scanning lines, for successively selecting the scanning lines, and a controller for controlling the signal line driving circuit and the scanning line driving circuit, the controller including means for turning off the selecting circuits in a blanking period.

### CROSS-REFERENCE TO RELATED APPLICATIONS

This application is based upon and claims the benefit of priority from prior Japanese Patent Application No. 2004-300119, filed Oct. 14, 2004, the entire contents of which are incorporated herein by reference.

### BACKGROUND OF THE INVENTION

1. Field of the Invention

The present invention relates to a liquid crystal display device and a method of driving the same, and in particular to an active matrix type liquid crystal display device and a method of driving the same.

2. Description of the Related Art

In general, a liquid crystal display device comprises pixels arranged in a matrix in a display section, a plurality of signal lines for supplying image signals to respective columns of pixels, a signal line driving circuit connected to the signal lines, a plurality of scanning lines for use in selecting respective rows of pixels, and a scanning line driving circuit connected to the scanning lines. An image is displayed at a pixel that is connected to a scanning line selected by the scanning line driving circuit and a signal line selected by the signal line driving circuit. The signal line driving circuit supplies image signals to respective pixels on the scanning line selected by the scanning line driving circuit.

In a method of driving the above liquid crystal display device, an image displaying period and a blanking period are present. In the image displaying period, an image is displayed, and in the blanking period, no image is displayed. However, conventionally, even in the blanking period, an image signal is supplied to a signal line, and thus current flows in the signal line, thus consuming surplus power.

### BRIEF SUMMARY OF THE INVENTION

The present invention has been made in view of the above problem, and its object is to reduce the power consumption of a liquid crystal display device without complicating the circuit structure thereof.

A liquid crystal display device according to an embodiment of the present invention comprises: a plurality of pixels arranged in a matrix on a substrate; a plurality of signal lines provided for respective columns of the pixels, which supply image signals to a group of pixels in each of the columns; a plurality of scanning lines provided for respective rows of the pixels, which select a group of pixels in each of the rows; a signal line driving circuit including selecting circuits for supplying, in each of horizontal periods, a number of image signals of the image signals that are respectively associated with a number of signal lines of the signal lines, and other image signals of the image signals that are respectively associated with other signal lines of the signal lines; a scanning line driving circuit connected to the plurality of scanning lines, for successively selecting the scanning lines; and a controller for controlling the signal line driving circuit and the scanning line driving circuit, the controller including means for turning off the selecting circuits in a blanking period.

According to the present invention, each of the selecting circuits is applied to respective two of the signal lines, that is, each selecting circuit supplies associated two signals to the respective two signal lines. Due to this feature, the circuit structure is not complicated. In addition, in the invention, in a vertical blanking period, the switching operations of the selecting circuits are stopped. Thus, the power consumption of the liquid crystal display device can be reduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for use in explaining an example of the structure of a liquid crystal display device according to an embodiment of the present invention.

FIG. 2 is a view for use in explaining an example of inputting of image signals to signal lines shown in FIG. 1.

FIG. 3 is a view for use in explaining another example of inputting of image signals to the signal lines shown in FIG. 1.

FIG. 4 is a view for use in explaining an example of transmission of image signals in a signal line driving circuit shown in FIG. 1.

FIG. 5 is a view for use in explaining another example of transmission of image signals in the signal line driving circuit shown in FIG. 1.

FIG. 6 shows an example of the structure of a connection portion between signal lines and the signal line driving circuit in the liquid crystal display device shown in FIG. 1.

FIG. 7 is a timing chart of timing signals generated by a controller shown in FIG. 1.

FIG. 8 shows an example of the circuit structure of a switch control circuit which outputs a switch control signal.

FIG. 9 is a view showing an example of the phases of switch control signals of the switch control circuit shown in FIG. 8.

FIG. 10 is a view for use in explaining an example of the operation of a signal line driving circuit shown in FIG. 1.

### DETAILED DESCRIPTION OF THE INVENTION

A liquid crystal display device according to an embodiment of the present invention will be explained with reference to the accompanying drawings.

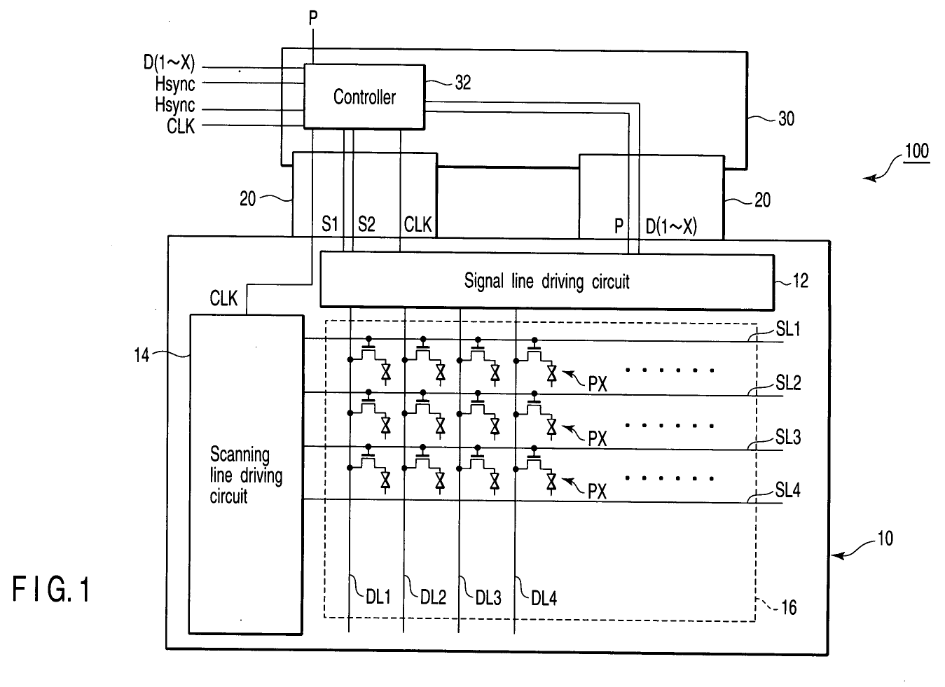

FIG. 1 is a view for schematically showing the structure of a liquid crystal display device 100 according to the present invention. As shown in FIG. 1, the liquid crystal display device 100 includes pixels PX arranged in a matrix in an effective display section 16 on a liquid crystal display panel 10. Furthermore, a plurality of signal lines DL (DL1, DL2, DL3, . . . ) for use in supplying image signals D (D1 to DX) are connected to respective columns of pixels PX, and also to a signal line driving circuit 12. Also, a plurality of scanning lines SL (SL1, SL2, SL3, . . . ) are connected to respective rows of pixels PX, and also to a scanning line driving circuit 14.

The liquid crystal display panel 10 includes terminals electrically connected to a control section 30 (provided on a substrate) by a pair of tape automated bonding (TAB) substrates 20. The control section 30 transmits a clock signal CLK, image signals D (D1 to DX), a power supply signal P, and switch control signals S1 and S2, etc. to the liquid crystal panel 10. Also, the control section 30 includes a controller 32 for controlling the signal line driving circuit 12 and the scanning line driving circuit 14.

The controller 32 receives the clock signal CLK, the power supply signal P, a vertical synchronizing signal Vsync, a horizontal synchronizing signal Hsync, and the image signals D (D1 to DX), etc., and transmits the switch control signals S1 and S2, the clock signal CLK, the power supply signal P and the image signal D (D1 to DX), etc. to the signal line driving circuit 12.

The scanning line driving circuit 14 receives the clock signal CLK from the controller 32, and successively selects the scanning lines SL in accordance with the clock signal CLK.

The signal line driving circuit 12 receives the switch control signals S1 and S2 from the controller 32, and supplies image signals D (D1 to DX), which are accumulated in advance, to pixels PX connected to a scanning line SL selected by the scanning line driving circuit 14, in accordance with the switch control signals S1 and S2.

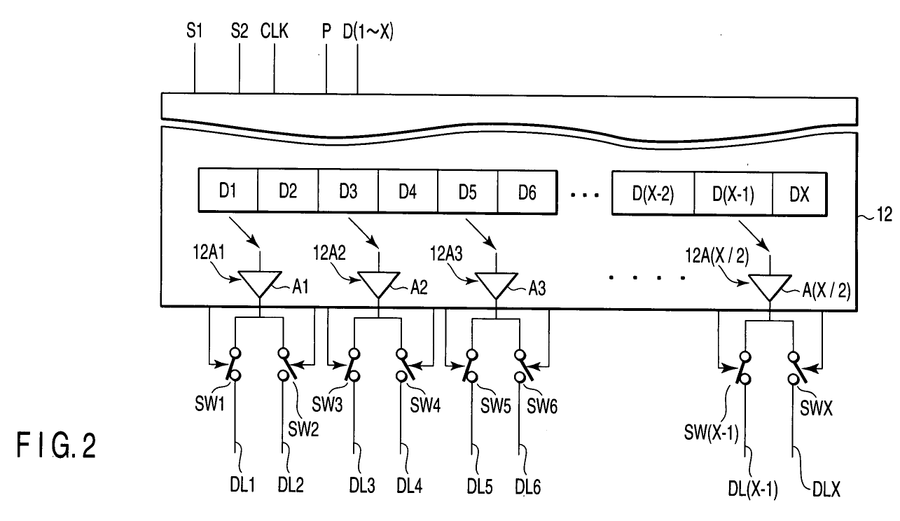

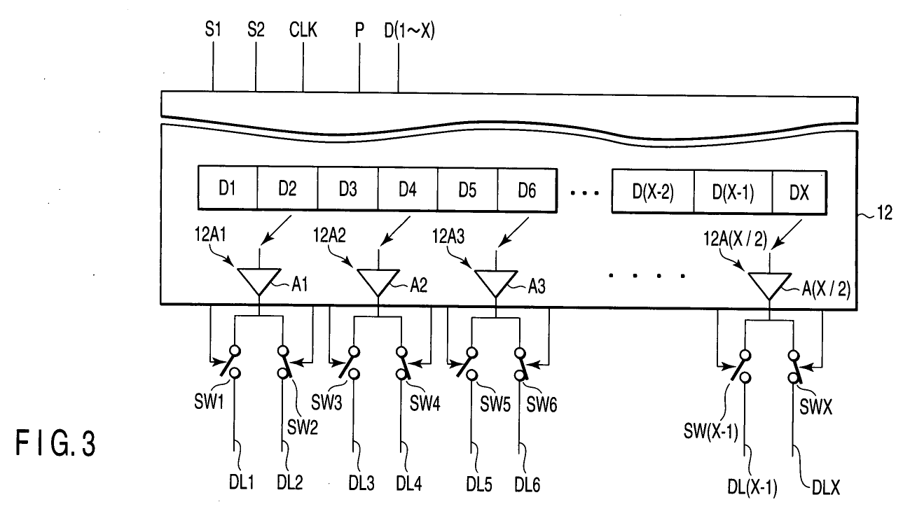

FIGS. 2 and 3 are views for use in explaining how image signals D (D1 to DX) are input to signal lines DL in the signal line driving circuit 12. As shown in FIGS. 2 and 3, the signal line driving circuit 12 includes selecting circuits 12A (12A1 to 12A(X/2)) which are provided at connection portions between the signal line driving circuit 12 and the signal lines DL, and each of which supplies an image signal to a selected one of associated two signal lines.

Of the selecting circuits 12A (12A1 to 12A(X/2)), for example, a selecting circuit 12A1 comprises a liquid crystal driver A1 and selecting switches SW1 and SW2 each formed of a field effect transistor (FET). The selecting switch SW1 is connected to the signal line DL1, and the selecting switch SW2 is connected to the signal line DL2. The selecting circuit 12A1 is connected to the signal lines DL1 and DL2 through the selecting switch SW1 and SW2, and supplies the image signals D1 and D2 to respective pixels.

Referring to FIG. 2, selecting switches SW1, SW3, SW5, . . . respectively connected to the signal lines DL1, DL3, DL5, . . . are in the ON state. In this case, the image signals D1, D3, D5, . . . respectively associated with the signal lines DL1, DL3, DL5, . . . are input to the selecting circuits 12A1, 12A2, 12A3,.

On the other hand, referring to FIG. 3, selecting switches SW2, SW4, SW6, . . . respectively connected to the signal lines DL2, DL4, DL6, . . . are in the ON state. In this case, the image signals D2, D4, D6, respectively associated with the signal lines DL2, DL4, DL6, . . . are input to the selecting circuits 12A1, 12A2 12A3, . . . .

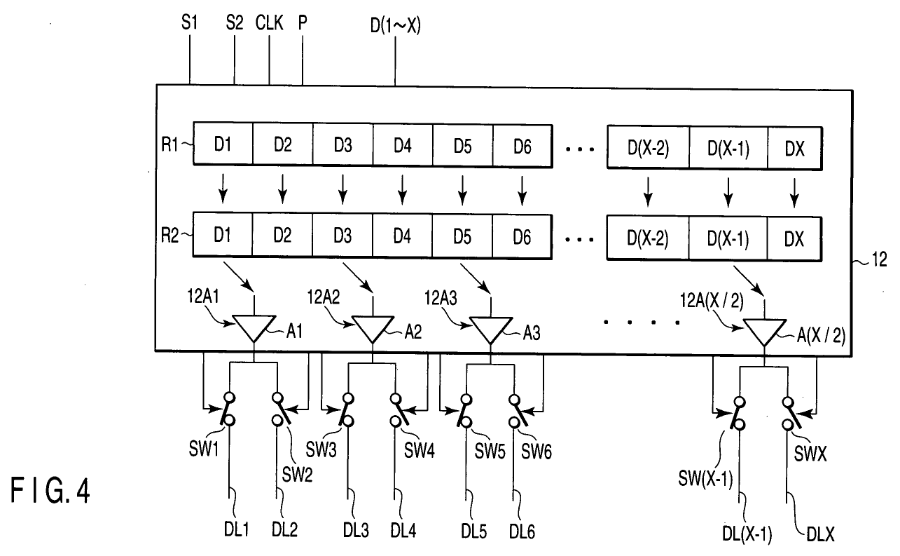

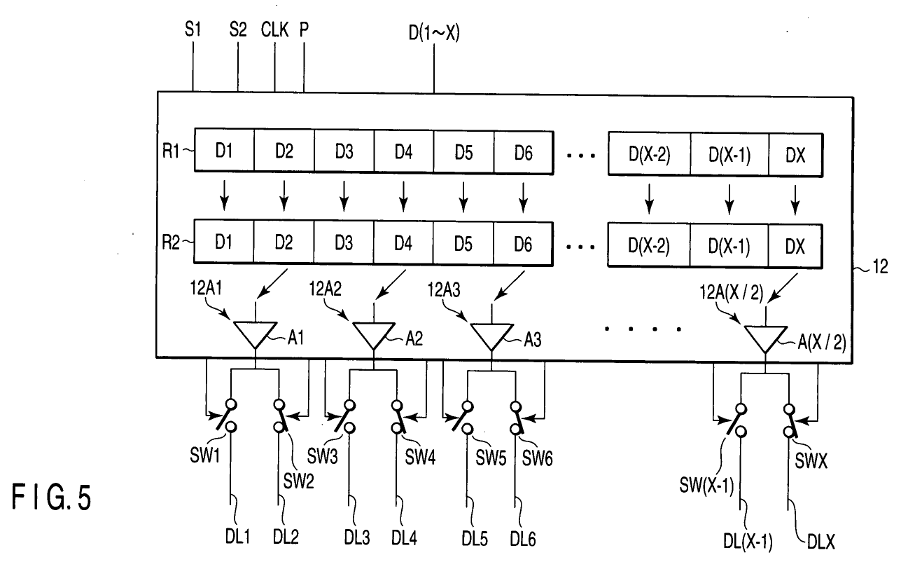

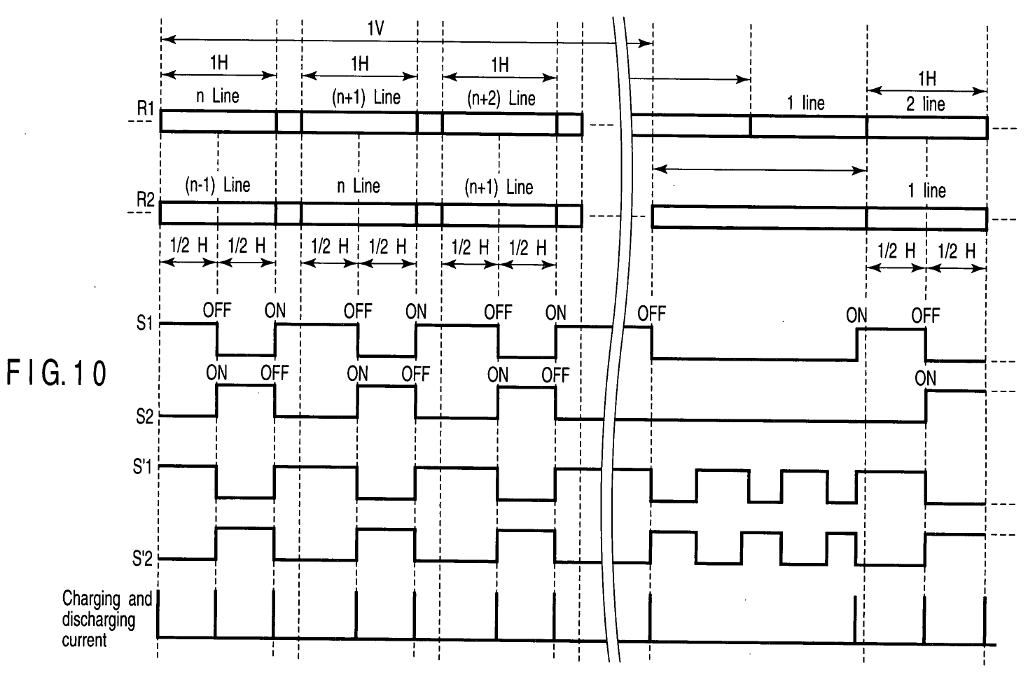

Then, the operation of the signal line driving circuit 12 will be explained with reference to FIGS. 4, 5 and 10 in detail. As shown in FIGS. 4, 5 and 10, image signals D (D1 to DX) of an n-th horizontal line input from the controller 32 to the signal line driving circuit 12 are input to a shift register R1. Then, the shift register R1, as shown in FIG. 10, transmits the image signals D (D1 to DX) of the n-th horizontal line to a shift register R2 in a horizontal blanking period. At this time, image signals D (D1 to DX) of an (n+1)-th horizontal line are input to the shift register R1.

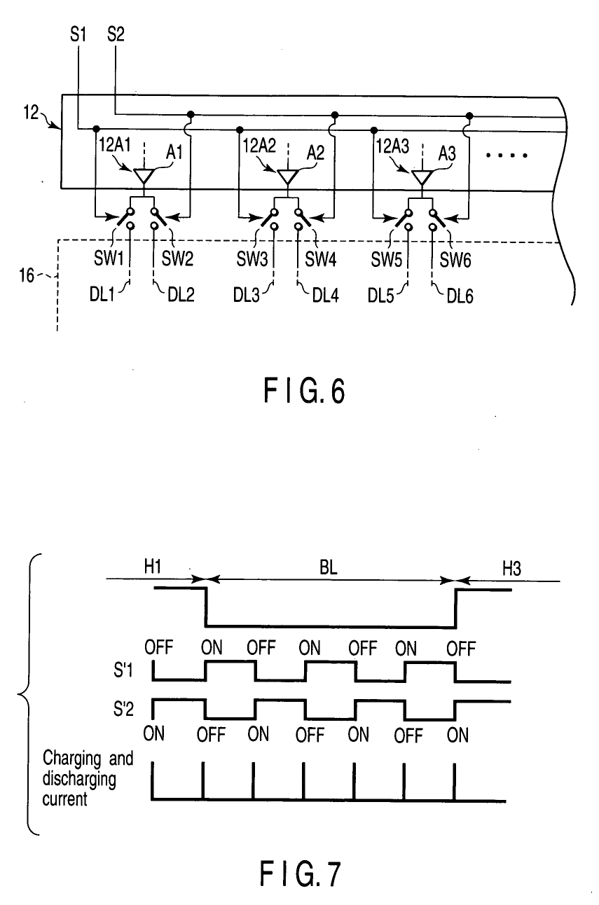

After receiving the image signals D (D1 to DX) of the n-th line, as shown in FIG. 4, the shift register R2 transmits odd-numbered image signals D (D1, D3, D5, . . .) to the selecting circuits 12A (12A1 to 12A(X/2)) in a ½ horizontal period. In the other ½ horizontal period, the shift register R2 transmits even-numbered image signals D (D1, D3, D5, . . . ) to the selecting circuits 12A (12A1 to 12A(X/2)) as shown in FIG. 6.

That is, the selecting circuits 12A (12A1 to 12A(X/2)) supply image signals associated with respective signal lines SL in each horizontal period, e.g., in a ½ horizontal period, the selecting circuits 12A (12A1 to 12A(X/2)) supply the image signals associated with the half of the signal lines DL. Also, in, e.g., the remaining ½ horizontal period, the selecting circuits 12A (12A1 to 12A(X/2)) supply the remaining image signals associated with the remaining signal lines DL, i.e., the image signals of ½ of a horizontal line.

The selecting circuits 12A (12A1 to 12A(X/2)) provided in the signal line driving circuit 12 have the same structure. Thus, they will be explained mainly by referring to the selecting circuit 12A1.

As stated above, the selecting circuits 12A (12A1 to 12A(X/2)) supply associated image signals to associated signal lines DL in each horizontal period in such a manner as to supply a number of image signals respectively associated with a number of signal lines DL in a half horizontal period, and then supply other image signals respectively associated with other signal lines DL in a subsequent half horizontal period. Thus, the number of liquid crystal drivers A (A1 to A(X/2)) can be reduced.

Next, the switch control signals S1 and S2 will be explained. FIG. 6 shows an example of the structure of a connection portion between the signal line driving circuit 12 and the signal lines DL. As shown in FIG. 6, turning on and off of the selecting switches SW1, SW3, SW5, . . . of the selecting circuits 12A (12A1 to 12A(X/2)) are controlled by the switch control signal S1 supplied from the controller 32. On the other hand, turning on and off of the selecting switches SW2, SW4, SW6, . . . of the selecting circuits 12A (12A1 to 12A(X/2)) are controlled by the switch control signal S2 supplied from the controller 32.

As shown in FIG. 10, for example, the selecting switches SW1, SW3, SW5, . . . are turned on when the switch control signal S1 is set to “H”, and are turned off when the switch control signal S2 is set to “L”.

That is, the selecting switches SW1 and SW2 of the selecting circuit 12A1 are alternately turned on and off at predetermined intervals in a period other than the blanking period, by the switch control signals Si and S2, respectively. Similarly, turning on and off of selecting switches SW (SW3 to SWX) of the other selecting circuits 12A (12A2 to 12A(X/2)) are toggled by the switch control signal S1 and S2.

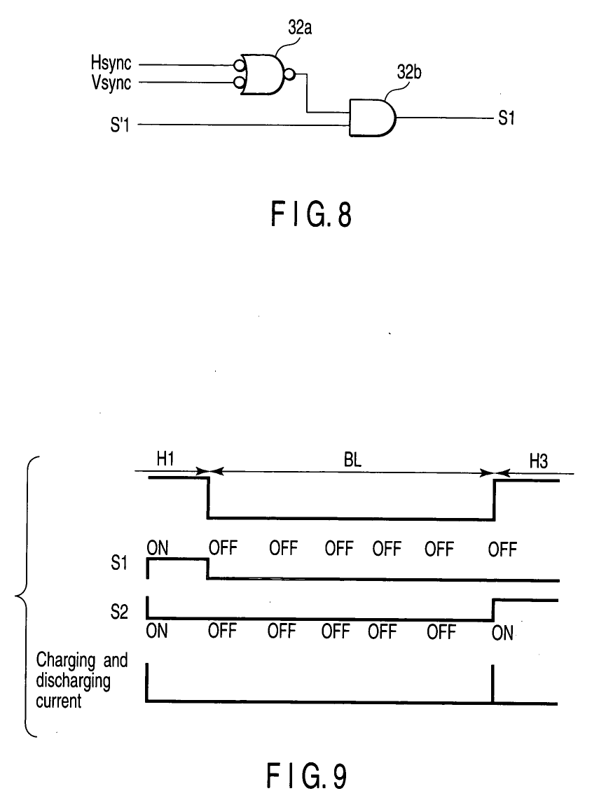

FIG. 7 is a timing chart of timing signals S′1 and S′2 which are generated by the controller 32 by using vertical synchronizing signals Vsync and horizontal synchronizing signals Hsync. FIG. 8 shows an example of the structure of a switch control circuit which outputs the switch control signal S1.

The timing signals S′1 and S′2 are generated by combining vertical synchronizing signals Vsync and horizontal synchronizing signals Hsync in the controller 32. Assertion (ON) and negation (OFF) of timing signals S′1 and S′2, as shown in FIG. 7, are alternately toggled at predetermined intervals in image displaying periods H1 and H3 in each of which an image is displayed and a blanking period BL in which no image is displayed (e.g., a vertical blanking period).

The switch control circuit shown in FIG. 8 is provided in the controller 32, and includes a NOR circuit 32A and an AND circuit 32B. The horizontal synchronizing signal Hsync and the vertical synchronizing signal Vsync are inverted and input to the NOR circuit 32A. The timing signal S′1 and the output signal of the NOR circuit 32A are input to the AND circuit 32B. From the AND circuit 32B, the switch control signal S1 is output.

By virtue of the above circuit structure, as shown in FIG. 9, in the image displaying periods H1 and H3, assertion (ON) and negation (OFF) of the switch control signal S1 corresponding to the output of the AND circuit 32B are repeatedly toggled at predetermined intervals, and in the blanking period BL, the switch control signal S1 serves as an L signal for turning off the selecting switches SW1, SW3, SW5 . . . .

A switch control circuit (not shown) which outputs the switch control signal S2 (i.e., a signal for controlling the selecting switches SW2, SW4, SW6 . . . ) has the same structure as the abovementioned switch control circuit, and has the following feature: the horizontal synchronizing signal Hsync and the vertical synchronizing signal Vsync are input to the NOR circuit of the switch control circuit, and the output signal of the NOR circuit and the timing signal S′2 are input to the AND circuit of the switch control circuit. From the AND circuit, the switch control signal S2 is output.

The above switch control signals S1 and S2 both turn off the selecting switches SW (SW1 to SWX) in the blanking period. FIG. 9 is a timing chart of the switch control signals S1 and S2, i.e., the outputs of the switch control circuit shown in FIG. 8. As shown in FIG. 9, in the image displaying periods H1 and H3, the selecting switches SW1 and SW2 are controlled such that their ON and OFF states are opposite to each other. In the blanking period BL, an L signal for turning off all the selecting switches SW1, SW3, SW5 . . . and SW2, SW4, SW6 . . . is output. That is, in the blanking period BL, the selecting switches are all turned off, as a result of which a charging and discharging current does not flow in the signal lines DL.

As stated above, the controller 32 is provided with the switch control circuit, and performs a control for turning off the selecting switches in the blanking period, thereby reducing surplus power consumption which would be increased if a charging and discharging current flowed in the blanking period BL. Furthermore, it should be noted that as the blanking period BL, it is effective to apply a vertical blanking period. However, as the blanking period BL, a horizontal blanking period may be applied, that is, the selecting switches may be turned off in the horizontal blanking period.

According to the present invention, the selecting circuits are set such that each of the selecting circuits supplies one of associated two image signals to one of associated two signal lines, and also the other image signal to the other signal line, as a result of which the circuit structure is simple. Furthermore, in the invention, the switch control circuit is set to turn off all the selecting switches in the blanking period, thereby reducing the power consumption. To be more specific, when the present invention was applied to a conventional liquid crystal display device, and the power consumption thereof was measured, it was found that the power consumption was smaller than that of the conventional liquid crystal device not adopting the present invention by 30 mW.

Moreover, it the above embodiment, the selecting circuits 12A (12A1 to 12A(X/2)) include the switches formed of FETs; however, they may include switches formed of thin film transistors (TFTs). That is, even if their switches are formed of TFTs, the same advantages can be obtained as in the above embodiment. In addition, in this case, the present invention can also be applied to a thinner liquid crystal display device.

The present invention is not limited to the above embodiment, that is, it can be put to practical use by modifying its structural elements without departing from its subject matter. Also, various inventions can be made by appropriately selectively combining the abovementioned structural elements explained with respect to the above embodiment. For example, some structural elements may be deleted from the above structural elements, or a number of structural elements thereof may be combined appropriately.

What is claimed is:

1. A liquid crystal display device comprising:
a plurality of pixels arranged in a matrix on a substrate;
a plurality of signal lines provided for respective columns of the pixels, which supply image signals to a group of pixels in each of the columns;
a plurality of scanning lines provided for respective rows of the pixels, which select a group of pixels in each of the rows;
a signal line driving circuit including selecting circuits for supplying, in each of horizontal periods, a number of image signals of the image signals that are respectively associated with a number of signal lines of the signal lines, and other image signals of the image signals that are respectively associated with other signal lines of the signal lines;
a scanning line driving circuit connected to the plurality of scanning lines, for successively selecting the scanning lines; and
a controller for controlling the signal line driving circuit and the scanning line driving circuit, the controller including means for turning off the selecting circuits in a blanking period.

2. The liquid crystal display device according to claim 1, wherein each of the selecting circuits includes two selecting switches formed of FETs, and the two selecting switches of said each selecting circuit are alternately turned on and off at predetermined intervals in a period other than the blanking period.

3. The liquid crystal display device according to claim 2, wherein:
the controller includes a switch control circuit for performing a control for turning off the selecting circuits in the blanking period, and alternately turning on and off the two selecting switches of said each selecting circuit in the period other than the blanking period; and
the switch control circuit includes a NOR circuit and an AND circuit.

4. The liquid crystal display device according to claim 1, wherein said each selecting circuit is controlled by the controller, and supplies image signals of the image signals supplied through the signal lines which are associated with a half of the plurality of signal lines, and then supplies other image signals of the image signals supplied through the signal lines which are associated with the other half of the plurality of signal lines.

5. A driving method of a liquid crystal display device comprising:
a plurality of pixels arranged in a matrix on a substrate;
a plurality of signal lines provided for respective columns of the pixels, which supply image signals to a group of pixels in each of the columns;
a plurality of scanning lines provided for respective rows of the pixels, which select a group of pixels in each of the rows;
a signal line driving circuit including selecting circuits each including a plurality of selecting switches;
a scanning line driving circuit connected to the scanning lines, for successively selecting the scanning lines; and
a controller for controlling the signal line driving circuit and the scanning line driving circuit, wherein the controller turns off the selecting switches of the selecting circuits in a blanking period, and causes the signal line driving circuit to supply, in each of horizontal periods, a number of image signals of the image signals that are respectively associated with a number of signal lines of the signal lines, and other image signals of the image signals that are respectively associated with other signal lines of the signal lines.

6. The driving method according to claim 5, wherein each of the selecting circuits includes two selecting switches, and the two selecting switches of said each selecting circuit are alternately turned on and off at predetermined intervals in a period other than the blanking period.

7. The driving method according to claim 5, wherein in said each of the horizontal periods, associated image signals of the image signals supplied through the signal lines that are associated with a half of the plurality of signal lines are supplied, and other image signals of the image signals supplied through the signal lines that are associated with the other half of the plurality of signal lines are supplied.

8. The driving method according to claim 5, wherein in said each of the horizontal periods, in a ½ horizontal period, associated ones of the image signals are supplied to odd-numbered ones of the signal lines, respectively, and in the other ½ horizontal period, other associated ones of the image signals are supplied to even-numbered ones of the signal lines, respectively.
